(19) United States
(12) Patent Application Publication
(10) Pub. No.: US 2006/0085956 A1
(43) Pub. Date: Apr. 27, 2006

(54) Adjustable bungee cord

(76) Inventor: Alan Stevens, Quathiaski-Cove (CA)

Correspondence Address: STEPHEN R. BURRI, MILLER THOMSON LLP, 1000 - 840 HOWE STREET, VANCOUVER, BC, V6Z 2M1, CA

(21) Appl. No.: 11/148,247

(22) Filed: Jun. 9, 2005

(30) Foreign Application Priority Data
Oct. 26, 2004 (CA) 2,486,086

(51) Int. Cl. A44B 21/00; F16G 11/00

(52) U.S. Cl. 24/300; 24/136 B

(57) ABSTRACT

A bungee cord length adjustment device comprises a housing which may be moved along a bungee cord to a selected position and releasably locked by a manual quarter rotation of a screw. A compression plate disposed between the lower end of the screw and the bungee cord permits dispersion of the frictional force about a relatively large surface area, reducing the potential for wear on the bungee cord. The bungee cord adjustor of the invention permits adjustment of the working length of a bungee cord, reducing the need for use of multiple bungee cords of differing lengths for the securing of goods of varying dimensions.

### TECHNICAL FIELD OF THE INVENTION

The present invention relates generally to bungee cords, and more particularly to a bungee cord having integral means to adjust the working length of the bungee cord.

### BACKGROUND OF THE INVENTION

Bungee cords are commercially available in a variety of lengths, or may be custom made to any desired length. However, bungee cords of a particular length are only functional within a limited elastic range for a particular length. It is desirable to provide an adjustable bungee cord to permit a wider range of functionality, and reduce the quantity of bungee cords needed for common applications such as transportation of goods by bicycle or motorcycle.

It is known to provide a device for adjusting bungee cords. Such devices are shown, for example, in U.S. Design Pat. No. D480,946 to Estep, Jr. entitled: “Adjustable-Length Bungee Strap” (“Estep”) and U.S. Pat. No. 6,049,950 to Cavallo entitled: “Method and Apparatus for Providing an Adjustable Cord” (“Cavallo”).

Estep describes two separate strap portions, one of which is fixed to a linking device. The linking device is attachable at a selected position on the non-fixed strap portion. Estep does not describe a locking means easily adjustable with one hand by the user.

In Cavallo, an adjustable bungee strap is described. The device includes one portion of a bungee strap fixed to a locking housing. A second bungee strap portion is slidably engaged with the locking housing. Locking means in the form of a pivoting hook co-linear with the second bungee strap portion may be rotated beyond a locking pin to engage the second bungee strap element at a desired position with a serrated edge on the base of the hook. The locking hook of Cavallo would not permit release with a simple quarter turn rotation of a screw. Also, the edge serration of the locking hook, while gripping a flat bungee strap, would not firmly grasp a bungee cord having a circular cross-section and the serrations would cause rapid wear of the bungee cord.

It is desirable in an adjustable bungee cord device that the device should be easily lockable and releasable with one hand. The point of contact between the locking mechanism and the cord should cover a relatively large surface area to distribute the locking force along the bungee cord. The bungee cord device should ideally be compact and usable in most circumstances where a standard bungee cord could be used.

### SUMMARY OF THE INVENTION

In one of its aspects, the present invention comprises an adjustable bungee cord comprising a bungee cord having a first hook fixedly attached to an end thereof, bungee length adjustment means slidably connected to the bungee cord for selectively positioning a second hook of opposite orientation to the first hook attached to the housing in a selected position a desired distance from the first hook, and positioning means for releasably locking the bungee length adjustment means at the selected position.

In one of its aspects, the bungee length adjustment means comprise a housing encircling the bungee cord. In another of its aspects, the positioning means comprises a screw threadable through the top of the housing between an unlocked position and a locked position, the screw having a handle with opposed ends releasably engageable with locking means disposed on the housing, and a compression plate disposed within the housing between the lower end of the screw and the bungee cord. Preferably, the difference in rotational position of the screw between the locked position and the unlocked position is no more than 100 degrees.

In yet another of its aspects, the compression plate comprises a lower concave surface engageable with the bungee cord and a recess in the upper surface for receiving the bottom of the screw. Further, the locking means may comprise a pair of extensions on the upper surface of the housing, each extension terminating in a latch engageable with a lipped recess in one end of the handle of the screw, the extensions positioned such that as the screw is rotated into the locked position, each extension will engage with the lipped recess in one end of the handle.

In yet another aspect, there may be a depression in the inside lower surface of the housing, the depression having a knurled surface.

In still a further of its aspects, the second hook may be attached to the housing by a second bungee cord portion.

In another embodiment, the invention comprises a bungee cord having a first hook fixedly attached to an end thereof, a housing encircling the bungee cord, the housing having a knurled depression in its inside lower surface, and a second hook of opposite orientation to the first hook, the housing slidably connected to the bungee cord for selectively positioning the second hook in a selected position a desired distance from the first hook, and a screw threadable through the top of the housing between an unlocked position and a locked position, for releasably locking the housing at the selected position, the screw having a handle with opposed ends releasably engageable with a pair of latched extensions on the upper surface of the housing engageable with a lipped recess in each end of the handle of the screw, the extensions positioned such that as the screw is rotated into the locked position, each extension will engage with the lipped recess in a corresponding end of the handle, and a compression plate disposed within the housing between the lower end of the screw and the bungee cord, the compression plate having a lower concave surface engageable with the bungee cord and a recess in the upper surface for receiving the bottom of the screw.

Other aspects of the invention will be appreciated by reference to the description of the preferred embodiment which follows and to the claims.

### BRIEF DESCRIPTION OF THE DRAWINGS

The invention will be described by reference to the preferred embodiment and the drawings thereof in which:

FIG. 1 is a perspective view of the adjustable bungee cord, according to the invention;

FIG. 2A is a cross-sectional view through line 2-2 of FIG. 1 of the adjustable bungee cord in the unlocked position, according to the invention;

FIG. 2B is a cross-sectional view through line 2-2 of FIG. 1 of the adjustable bungee cord in the locked position, according to the invention;

FIG. 3A is a cross-sectional view through line 3-3 of FIG. 1 of the adjustable bungee cord in the unlocked position, according to the invention; and

FIG. 3B is a cross-sectional view through line 3-3 of FIG. 1 of the adjustable bungee cord in the locked position, according to the invention.

### DETAILED DESCRIPTION OF THE BEST MODE AND PREFERRED EMBODIMENT OF THE INVENTION

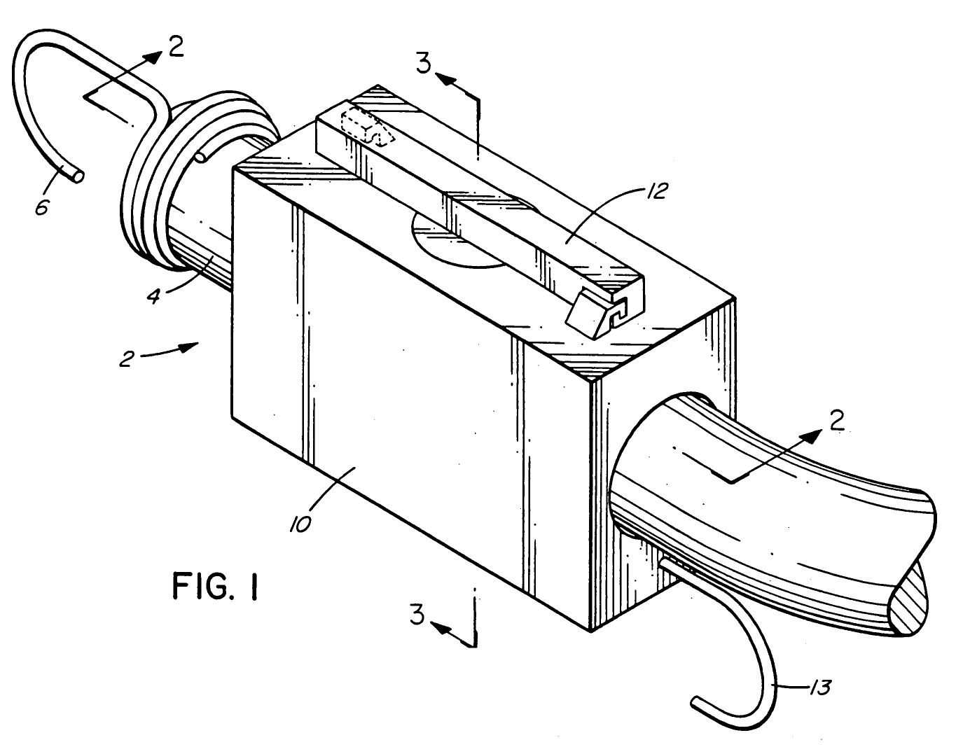

Referring first to FIG. 1, there is provided an adjustable bungee cord 2. The adjustable bungee cord includes a bungee cord portion 4 having a first hook 6 or other load attaching means at one end, and bungee cord adjustment means disposed at a selected position along the bungee cord portion 4. The bungee cord adjustment means comprises a housing 10 through which the bungee cord portion passes, positioning means 12, and a second hook 13 or other load attaching means fixed to the housing in opposite orientation to the first hook.

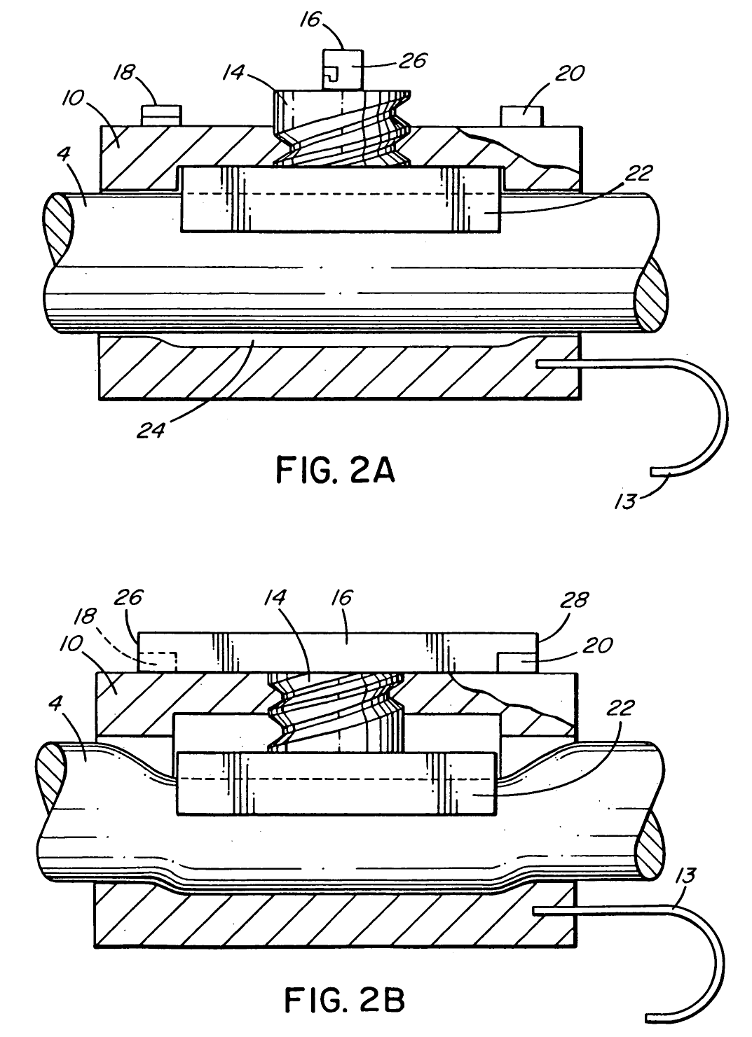

Referring now to FIG. 2A showing the adjustable bungee cord in an unlocked position, the bungee cord portion 4 extends through the housing 10 of the bungee adjustment means. The positioning means 12 comprises a threaded screw 14, a handle 16 fixed to the top of the screw, a pair of locking means which may be latches extending from the top surface of the housing 18, 20 and a compression plate 22 disposed between the end of the screw and the bungee cord element.

The housing further includes a second hook 13 fixed to the housing in opposite orientation to the first hook, and a cavity 24 in the housing opposite the compression plate for receiving the bungee cord portion in the locked position.

FIG. 2B shows the adjustable bungee cord in the locked position. The handle 16 has been rotated 90 degrees such that each end 26, 28 of the handle is engaged with a corresponding locking means 18, 20 of the housing. The screw 14 is exerting downward pressure on the compression plate 22, causing deflection of the bungee cord portion 4 into the cavity 24 of the housing.

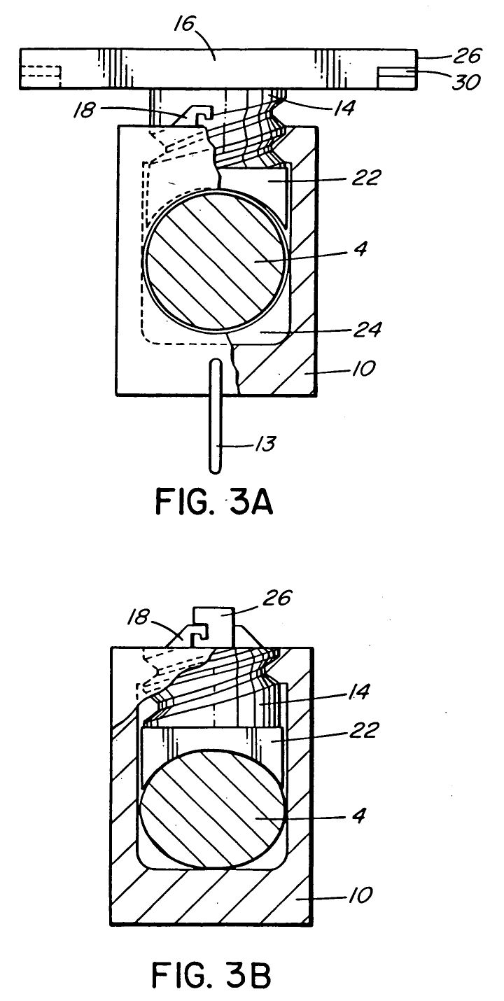

FIG. 3A depicts a transverse cross-section of the adjustable bungee cord device in an unlocked position. The lower edge of the compression plate 22 is concave to optimize area of surface contact between the compression plate 22 and the bungee cord portion 4. One end 26 of the handle 16 provides a lipped recess 30 engageable with a corresponding latch extending from the housing. A similar recess (not shown) on the opposite end of the handle is engageable with the opposing latch (not shown) extending from the housing.

As shown in FIG. 3B, clockwise rotation of the handle 16 by approximately 90 degrees will cause the screw to rotate downwardly into the housing, drawing the ends of the handle into alignment with the latches and exerting downward pressure on the bungee cord portion. Upon engagement of the latches and handle ends, the positioning means is stably fixed until downward rotational pressure is exerted on the handle to release the latches from the recesses on the ends of the handle.

The surface of the cavity and the bearing plate may be knurled to increase friction between the contact surfaces.

In operation, the positioning means of the adjustable bungee cord is released from the latches of the locking means by applying downward rotational pressure to the handle. The handle is then rotated 90 degrees counter-clockwise to loosen the contact between the compression plate and the bungee cord. The positioning means is slid along the bungee cord portion until the first and second hooks are a desired distance apart. The handle is then rotated 90 degrees clockwise and depressed until the ends of the handle engage with the latches of the housing. Rotation of the handle causes the screw to enter the housing, exerting pressure onto the compression plate. The compression plate exerts pressure onto the bungee cord, causing it to compress and deflect into the cavity. The positioning means will remain securely in the selected position until the handle is released from the locked position.

It will be appreciated by those skilled in the art that other variations of the preferred embodiment may also be practised without departing from the scope of the invention.

What is claimed is:

1. An adjustable bungee cord comprising:
a bungee cord having a first hook fixedly attached to an end thereof,
bungee length adjustment means slidably connected to the bungee cord for selectively positioning a second hook of opposite orientation to the first hook attached to the housing in a selected position a desired distance from the first hook, and
positioning means for releasably locking the bungee length adjustment means at the selected position.

2. The adjustable bungee cord of claim 1, wherein the bungee length adjustment means further comprises a housing encircling the bungee cord.

3. The adjustable bungee cord of claim 2 wherein the positioning means comprises a screw threadable through the top of the housing between an unlocked position and a locked position, the screw having a handle with opposed ends releasably engageable with locking means disposed on the housing, and a compression plate disposed within the housing between the lower end of the screw and the bungee cord.

4. The adjustable bungee cord of claim 3 wherein the difference in rotational position of the screw between the locked position and the unlocked position is no more than 100 degrees.

5. The adjustable bungee cord of claim 3 wherein the compression plate comprises a lower concave surface engageable with the bungee cord and a recess in the upper surface for receiving the bottom of the screw.

6. The adjustable bungee cord of claim 3 wherein the locking means comprises a pair of extensions on the upper surface of the housing, each extension terminating in a latch engageable with a lipped recess in one end of the handle of the screw, the extensions positioned such that as the screw is rotated into the locked position, each extension will engage with the lipped recess in one end of the handle.

7. The adjustable bungee cord of claim 2 further comprising a depression in the inside lower surface of the housing, the depression having a knurled surface.

8. The adjustable bungee cord of claim 1 further comprising a second bungee cord connecting the bungee length adjustment means to the second hook.

9. An adjustable bungee cord comprising:
a bungee cord having a first hook fixedly attached to an end thereof,
a housing encircling the bungee cord, the housing having a knurled depression in its inside lower surface, and a second hook of opposite orientation to the first hook, the housing slidably connected to the bungee cord for selectively positioning the second hook in a selected position a desired distance from the first hook, and
a screw threadable through the top of the housing between an unlocked position and a locked position, for releasably locking the housing at the selected position, the screw having a handle with opposed ends releasably engageable with a pair of latched extensions on the upper surface of the housing engageable with a lipped recess in each end of the handle of the screw, the extensions positioned such that as the screw is rotated into the locked position, each extension will engage with the lipped recess in a corresponding end of the handle, and a compression plate disposed within the housing between the lower end of the screw and the bungee cord, the compression plate having a lower concave surface engageable with the bungee cord and a recess in the upper surface for receiving the bottom of the screw.
